(19) United States
(12) Patent Application Publication
(10) Pub. No.: US 2018/0190974 A1
(43) Pub. Date: Jul. 5, 2018

(54) Sol-Gel Route for Nano Sized LiFePO4/C for High Performance Lithium Ion Batteries

(71) Applicants: UNIVERSITY OF SOUTH AFRICA, Pretoria (ZA); NANKAI UNIVERSITY, Tianjin (CN)

(72) Inventors: Ming Chen, Tianjin (CN); Xinying Liu, Randburg (ZA); Zhong-Yong Yuan, Tianjin (CN)

(21) Appl. No.: 15/738,546

(22) PCT Filed: Jun. 23, 2016
(86) PCT No.: PCT/IB2016/053743

§ 371 Date: Dec. 20, 2017

(30) Foreign Application Priority Data
Jun. 23, 2015 (ZA) 2015/04539

(51) Int. Cl. H01M 4/36; C01B 25/45; H01M 10/0525; H01M 4/58; H01M 4/62

(52) U.S. Cl. CPC H01M 4/362; C01B 25/45; H01M 4/625; H01M 4/5825; H01M 10/0525

(57) ABSTRACT

This invention relates to a novel a sol-gel method of synthesizing uniformly carbon-coated LiFeP0₄ (LiFeP0₄/AS). The method including the steps of: mixing a lithium source a phosphoric source and a carbon source with a solution containing Fe ions to form a gel; and calcining the gel to provide uniformly carbon-coated LiFeP0₄ (LiFePO₄/AS). According to the invention, the phosphoric source is a phosphonic acid.

### BACKGROUND OF THE INVENTION

This invention relates to a novel sol-gel route for preparing nano-sized LiFePO₄/C for high performance lithium ion batteries.

### SUMMARY OF THE INVENTION

According to the invention, there is provided a sol-gel method of synthesizing uniformly carbon-coated LiFePO₄ (LiFePO₄/AS), the method including the steps of:
mixing a lithium source a phosphoric source and a carbon source with a solution containing Fe ions to form a gel; and
calcining the gel to provide uniformly carbon-coated LiFePO₄ (LiFePO₄/AS);
   wherein the phosphoric source is a phosphonic acid.

The phosphoric source and the carbon source is preferably the same source, for example an organophosphonic acid such as amino tris (methylene phosphonic acid) or diethylene triamine penta (methylene phosphonic acid).

The lithium source may be selected from lithium carbonate, lithium nitrate, lithium acetate, lithium hydroxide and/or lithium oxalate.

The Fe ions may be from a ferrous source or a ferric source, preferably from a ferric. The ferrous source may be ferrous chloride, ferrous sulphate, ferrous oxalate, ferrous oxide and/or ferrous acetate, preferably ferrous oxalate. The ferric source may be ferric nitrate.

Preferably, the molar ratio of P:Fe:Li is 2.0-5.0:0.4-2.0; 1

Typically, the gel is dried, subjected to a pre-calcination step, and then calcined.

The pre-calcination step may be at 100-500° C. for 1-6 hours, with heating ramping rate of 1-10° C./min.

The calcination step may be at 500-1000° C. at a ramping rate of 1-20° C./min, and hold at the temperature for 2-10 hours.

### BRIEF DESCRIPTION OF THE DRAWINGS

FIG. 1 is an XRD pattern of the highly pure nano scale LiFePO4 power obtained from Example 2;

FIGS. 2 and 3 are TEM (transmission electron microscopy) images of the highly pure nano scale LiFePO4 power obtained from Example 2;

FIG. 4 is a graph showing the hysteresis loop of the highly pure nano scale LiFePO4 power obtained from Example 2;

FIG. 5 is a graph showing the initial charge-discharge curve of the highly pure nano scale LiFePO4 power obtained from Example 2;

FIGS. 6 and 7 are TEM (transmission electron microscopy) images of the highly pure nano scale LiFePO4 power obtained from Example 3; and

FIGS. 8 and 9 are graphs showing the short cycle and long cycle at various rate capability of the highly pure nano scale LiFePO4 power obtained from Example 3;

### DETAILED DESCRIPTION OF THE INVENTION

This invention relates to a novel method of synthesize uniformly carbon coated LiFePO₄ (LiFePO₄/AS) using a carbon source assisted sol-gel method in situ chelating lithium ion onto the organic phosphonic acid to form a gel with Fe and carbon sources in aqueous solution followed by heat treatment.

Stoichiometric amounts of iron source, lithium source, a co-phosphoric/carbon source and optionally additional carbon source are added to a corundum mortar. The molar ratio of P:Fe:Li is 2.0-5.0:0.4-2.0; 1. The mixture turned into a sol after certain amount of deionized water was added. The sol was milled to form a yellow gel following the evaporation of water.

The obtained yellow gel was dried at ambient temperature over 12 hours before sent to pre-calcination at 100-500° C. for 1-6 hours, with heating ramping rate of 1-10° C./min.

The resulting products were cooled and grinded at ambient temperature before calcined at 500-1000° C. at a ramping rate of 1-20° C./min, and hold at the temperature for 2-10 hours.

Target material was obtained once cooled down to ambient temperature.

Lithium source covers Lithium carbonate, lithium nitrate, lithium acetate, lithium hydroxide and/or lithium oxalate.

The co-phosphoric/carbon source is an organo phosphonic acid such as amino tris (methylene phosphonic acid) or diethylene triamine penta (methylene phosphonic acid).

Iron source is covers ferrous chloride, ferrous sulphate, ferrous oxalate, ferrous oxide and/or ferrous acetate, but is preferably a ferric source for example ferric nitrate.

The additional carbon source may be starch, cellulose, citric acid, polyethylene glycol, ascorbic acid, phenolic resin, sucrose, glucose and/or asphalt

Addition elements are at least one of the carbonate, phosphate, nitrate and/or oxide of transition metals and/or rare earth metals.

The experiment was conducted under a non-oxidation gas including but not limited to nitrogen and argon.

The advantage of such methods are:
1) lithium ion chelating onto the organic phosphonic acid molecules forms a molecule scale homogeneous sol which can obviously improve the purity of LiFePO₄;
2) the organic carbon contained in the organic phosphonic acid and addition carbon source can form a uniform distributed conductive carbon network in the LiFePO₄ particles which hinders the particle growth and aggregation under high temperature treatment;
3) phosphonic acid also functions as a reduction agent to reduce ferric compounds into ferrous compounds.

Tap density can be improved compare to conventional method using NH₄H₂PO₄ as phosphoric source and sucrose as carbon source.

### EXAMPLES

### Example 1

ATMP, LiOH, sucrose (optional) and Fe(NO₃)₃ were added to form a sol-gel, dried at 70° C. for 24 hrs, pre-calcined at 350° C. for 3 hours under Nitrogen, then calcined at 700° C. for 3 hours to form LiFePO₄/C material.

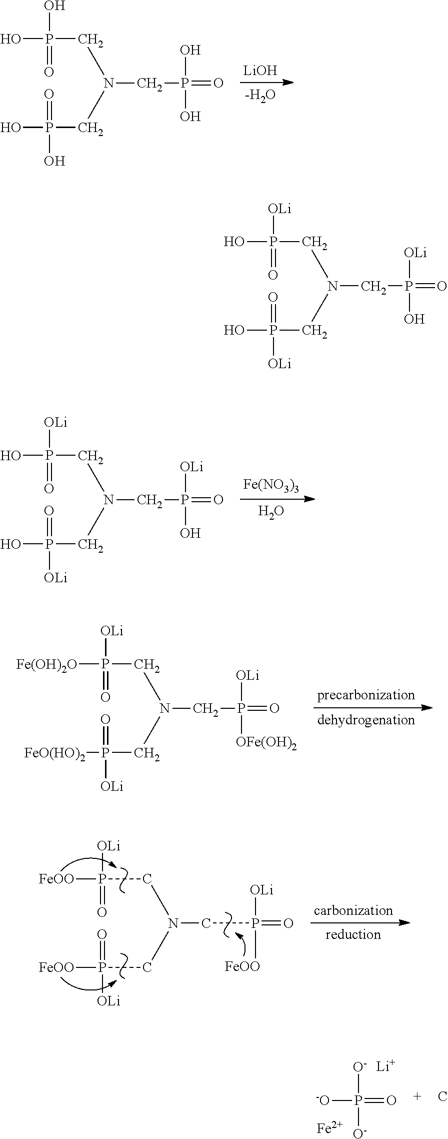

Advantage of using ferric instead of ferrous: ferric source is more stable at the ambient condition to provide a stable iron resource, and normally cheaper.

Advantage of using phosphonic acid as reducing agent: function as the phosphorous and carbon resource while as a reducing agent, to save additional cost of another reducing agent.

### Example 2

4.2 g ATMP (N(CH₂PH₂O₃)₃) was mixed with 7.2 g ferrous oxalate (FeC₂O₄) and 1.7 g LiOH, was added in a agate mortar with 6 ml in it. The mixture was stirred to form a yellow sol-gel. Moisture was vaporized before the yellow sol-gel in put into a furnace. The sample is protected by N2. With ramping rate of 2 C/min, the sample was precalcined at 350° C., and then calcined at 700° C. for 3 hours. Sample was then cooled to ambient temperature. Highly pure nano scale LiFePO4 power is obtained.

FIG. 1 is a XRD pattern of the highly pure nano scale LiFePO4 power. This shows the obtained sample has an olivine based pure orthorhombic phase structure.

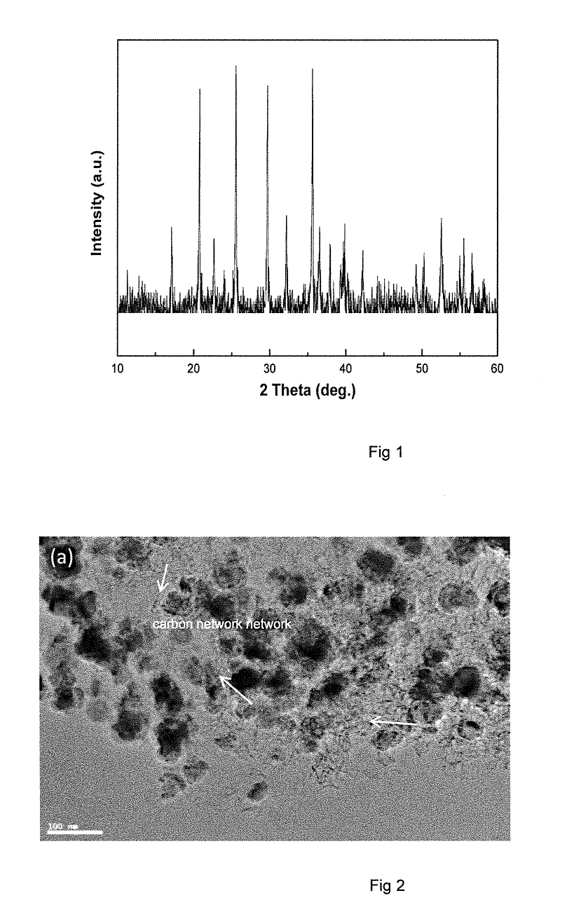

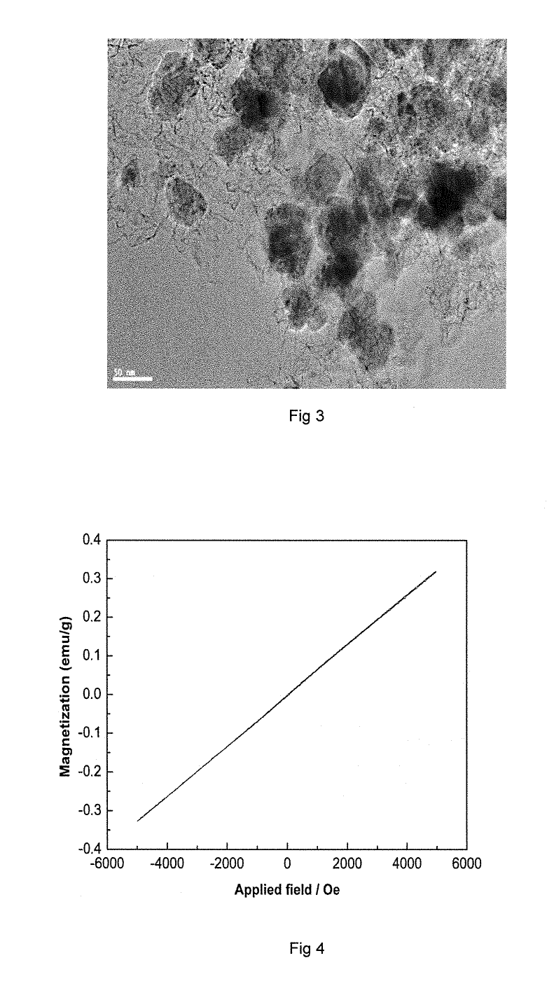

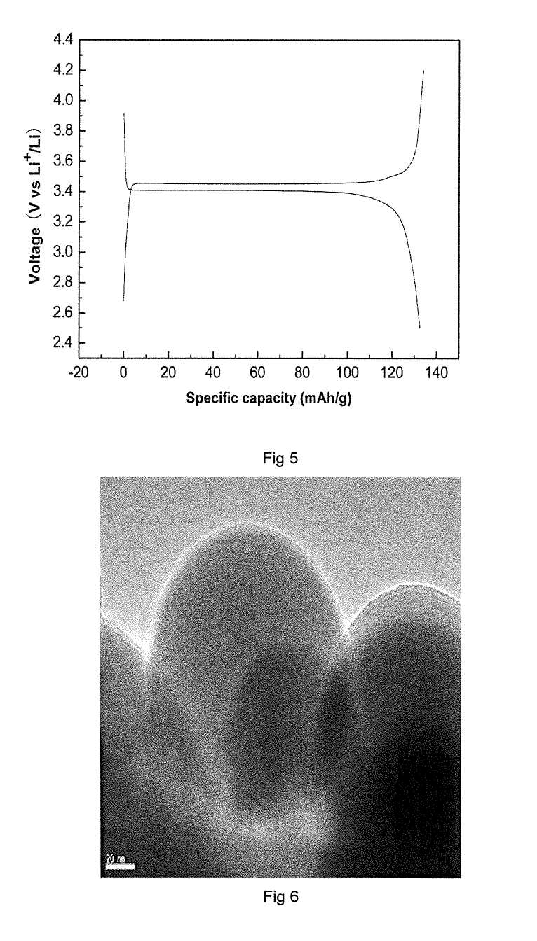

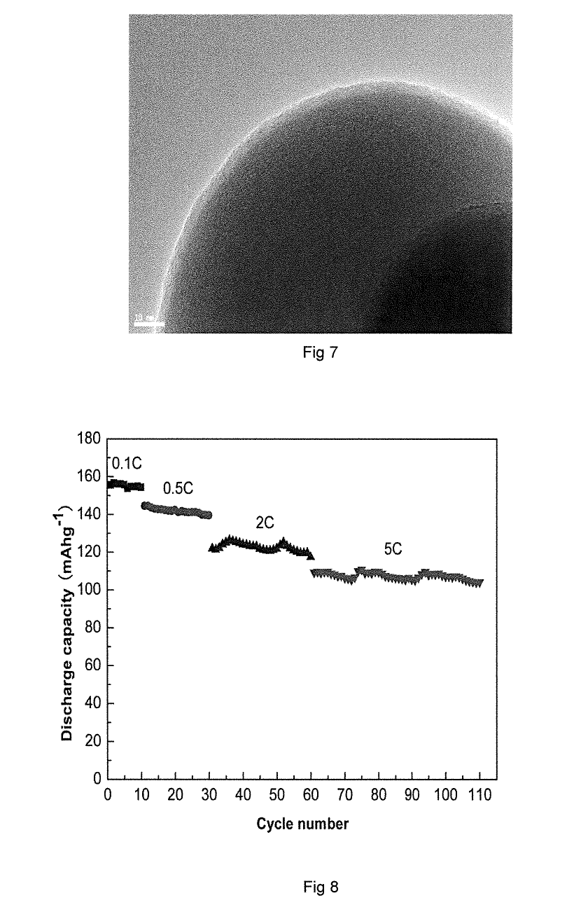

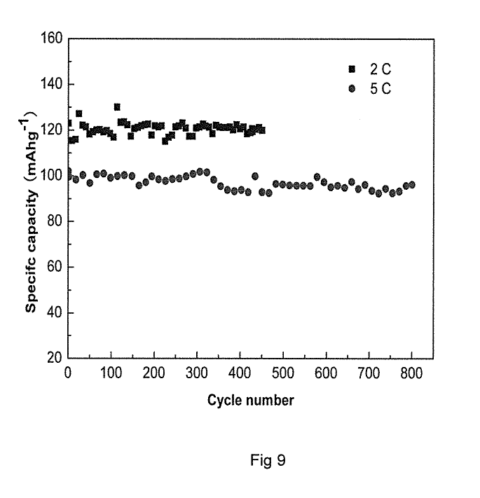

FIGS. 2 and 3 are TEM (transmission electron microscopy) images of the highly pure nano scale LiFePO4 power. The TEM images show that the carbon is distributed among LiFePO4 particles, and functions as a bridge to conduct electrons.

FIG. 4 is a graph showing the hysteresis loop of the highly pure nano scale LiFePO4 power. This indicates the high purity of the material.

### Example 3

4.2 g ATMP was mixed with 7.2 g ferrous oxalate and 1.7 g LiOH, was added in an agate mortar with 6 ml in it. 0.6 grams of sucrose was added in the mixture. The mixture was stirred to form a yellow sol-gel. Same treatment shown in Example 2 was conducted. The crystal size is reduced compared to Example 2. The specific capacity at 0.1 C rate capability is 158 mAh/g, and good recycle ability is shown at various rate capability.

FIGS. 2 and 3 are TEM (transmission electron microscopy) images of the highly pure nano scale LiFePO4 power.

### Example 4

4.2 g ATMP was mixed with 7.2 g ferrous oxalate and 1.7 g LiOH, was added in an agate mortar with 6 ml in it. 0.6 grams of sucrose and 0.14 g ammonium metavanadate are added in the mixture. The mixture was stirred to form a yellow sol-gel. Same treatment shown in Example 2 was conducted. The LiFePO4 crystal structure is changed after V is added in the system. The specific capacity at 5 C rate capability is 120 mAh/g.

### Example 5

HEDP (CH₃C(OH)(PH₂O₃)₂) is used instead of ATMP in Example 2.

### Example 6

FeCl₂ is used instead of FeC₂O₄ in Examples 2, 3 and 5.

### Example 7

Li₂CO₃ is used instead of LiOH in Examples 2 and 3.

### Example 8

Ethanol is used instead of water in Examples 2 and 3.

### Example 9

A mixture of ethanol and water is used instead of water in Examples 2 and 3.

### Example 10

LiF is used instead of LiOH in Examples 2, 3 and 4.

### Example 11

Ni(CH₃COOH)₂ is used instead of NH₄VO₃ in Examples 4 and 10.

### Example 12

(NH₄)₂Mo₂O₇ is used instead of NH₄VO₃ in Examples 4 and 10.

### Example 13

Mg(NO₃)₂ is used instead of NH₄VO₃ in Examples 4 and 10.

### Example 14

(NH₄)₁₀W₁₂O₄₁ is used instead of NH₄VO₃ in Examples 4 and 10.

### Example 15

4.2 g ATMP, 1.7 g LiOH.H₂O power were mixed in the mortar; 0-6 grams of sucrose is dissolved in 30 ml water. 6 ml of sucrose solution was added to the ATMP-LiOH mixture. 16.3 g Fe(NO₃)₃.9H₂O was added to the mixture. Mix till all ferric nitrate dissolved. Sol gel formed was dried at 70° C. for 24 hour, 350° C. under N₂ for 3 hour, then 700° C. under N2 for 3 hours.

1. A method of synthesizing uniformly carbon-coated LiFePO₄ including the steps of:
mixing a lithium source, a phosphoric source and a carbon source with a solution containing Fe ions, wherein the molar ratio of P:Fe:Li is 2.0-5.0:0.4-2.0:1, adding water to form a sol and milling the sol following evaporation of water to form a gel; and
calcining the gel to provide uniformly carbon-coated LiFePO₄ (LiFePO₄/AS);
wherein the phosphoric source is a phosphonic acid, and the Fe ions are from a ferric source.

2. The method claimed in claim 1, wherein the phosphoric source and the carbon source is the same source.

3. The method claimed in claim 2, wherein the phosphoric source is an organophosphonic acid.

4. The method claimed in claim 3, wherein the organophosphonic acid is amino tris (methylene phosphonic acid) or diethylene triamine penta (methylene phosphonic acid).

5. The method claimed in claim 1, wherein the lithium source is selected from lithium carbonate, lithium nitrate, lithium acetate, lithium hydroxide and/or lithium oxalate.

6. The method claimed in claim 1, wherein the ferric source is ferric nitrate.

7. (canceled)

8. (canceled)

9. (canceled)

10. (canceled)

11. (canceled)

12. (canceled)

13. The method claimed in claim 1, wherein the gel is dried, subjected to a pre-calcination step, and then calcined.

14. The method claimed in claim 13, wherein the pre-calcination step is at 100°-500° C. for 1-6 hours, with heating ramping rate of 1-10° C./min.

15. The method claimed in claim 13, wherein the calcination step is at 500-1000° C. at a ramping rate of 1-20° C./min, and hold at the temperature for 2-10 hours.

16. A uniformly carbon-coated LiFePO₄ (LiFePO₄/AS) prepared by the method of claim 1, wherein the molar ratio of P:Fe:Li is 2.0-5.0:0.4-2.0:1.
